(19) United States
(12) Patent Application Publication
(10) Pub. No.: US 2009/0146338 A1
(43) Pub. Date: Jun. 11, 2009

(54) PROCESS FOR PREPARING POLYMER FIBERS

(76) Inventors: Hoe Hin CHUAH, Houston, TX (US); Cecilia Zuqi Tse, Katy, TX (US)

Correspondence Address: SHELL OIL COMPANY, P O BOX 2463, HOUSTON, TX, 772522463, US

(21) Appl. No.: 12/239,194

(22) Filed: Sep. 26, 2008

Related U.S. Application Data
(60) Provisional application No. 60/975,402, filed on Sep. 26, 2007.

(51) Int. Cl. B29C 47/88

(52) U.S. Cl. 264/177.17

(57) ABSTRACT

A process is provided for producing staple fibers that may be used in the formation of carpets from poly(trimethylene terephthalate). Poly(trimethylene terephthalate) may be melt spun to form filaments. The melt spun filaments may then be cooled with a liquid having a temperature of at most 20° C. The cooled filaments may then be drawn, and the drawn filaments may be cut into staple fibers. The resulting staple fibers have highly uniform physical characteristics such as denier, tenacity, and elongation at break that render the fibers particularly useful for forming carpets.

### CROSS-REFERENCE TO RELATED APPLICATION

This application claims the benefit of U.S. Provisional Application No. 60/975,402, filed Sep. 26, 2007, which is incorporated herein by reference.

### FIELD OF THE INVENTION

The present invention relates to a process for preparing staple fibers from polymers that are useful for conversion into carpets.

### BACKGROUND OF THE INVENTION

Carpet is generally constructed from a primary backing, a face yarn, a binding compound such as latex, and often a secondary backing. The face yarn may be formed of natural or synthetic fibers. The synthetic fibers useful in carpets are typically formed of polymers such as polyarnides or polyesters. Such synthetic fibers may be formed by a process in which molten polymer is extruded through tiny holes in a metal plate, or spinneret, to form filaments of the polymer.

Carpet is generally made from either bulked continuous filament (BCF) or from staple fiber. BCF is formed of continuous strands of polymer filaments that are combined to form yarn bundles. Staple fiber is formed of short lengths of fibers that are cut from the polymer filaments after being drawn. Staple fibers are formed into spun yarns by textile yarn spinning processes typically requiring the preparation steps of blending, carding, and drafting prior to spinning.

Staple fibers offer some advantages over BCF yarns in carpet manufacture. Staple fiber, when constructed into a higher face weight carpet—for example having a face weight of >32 oz/yd²—provides a carpet having more luxurious look and feel than BCF carpets of comparable face weight. Unlike a BCF yarn, a polymer staple fiber may also be blended with other synthetic or natural types of staple fibers to enhance carpet appearance, wear performance, and dyeing properties of yarns formed from the blend of staple fibers.

Poly(trimethylene terephthalate) (“PTT”) is a polyester that has been found to be especially desirable as a synthetic fiber for the formation of carpets. Carpets formed of PTT are very wear resistant, have good stain resistance, and have a soft feel. Therefore, recent efforts have been made in the carpet industry to develop PTT synthetic fibers, both as BCF yarns and staple fibers, for use in the formation of carpets.

Staple fibers formed of PTT for use in carpets have proven more difficult to prepare than other synthetic staple carpet fibers such as poly(ethylene terephthalate) and nylon. Following extrusion, PTT filaments have a very fast crystallization rate compared to filaments of other commonly used synthetic carpet fiber polymers. The fast crystallization rate of PTT increases the likelihood that the extruded filaments will crystallize to a significant degree. A significant degree of filament crystallinity, e.g. greater than 25%, renders drawing the filaments difficult or impossible since such filaments are brittle and prone to breaking during the draw process.

The relative thickness of PTT filaments used to produce staple fiber for use in carpets also increases the likelihood that the extruded filaments will crystallize to a significant degree relative to PTT filaments used to produce textile staple fibers. PTT filaments used to produce staple fibers for carpet typically are significantly thicker and have a larger denier than PTT filaments used to produce staple fibers for textiles. The thicker large denier filaments have less surface area to exchange heat than the thinner low denier filaments, therefore, more crystallization typically occurs in the thicker large denier PTT filaments prior to being cooled below the cold crystallization temperature of the polymer.

Further, the rapid crystallization rate of PTT leads to wide variation in the crystallinity of the filaments as they are spun. As a result, staple fibers produced from poly(trimethylene terephthalate) often vary significantly in length and denier since the crystallinity of the fibers affects the degree to which the staple fibers contract after being drawn and cut. Significant variation of staple fiber length or denier, e.g. 10% or more variation between fibers, renders processing the staple fibers into spun yarns for use in carpet difficult.

U.S. Patent Application Publication No. 2003/0197303 A1 provides a process for preparing PTT staple fibers for conversion into carpets. The process discloses a method for controlling the crystallization of the PTT filaments so the filaments have a crystallinity of less than or equal to 25%, or less than or equal to 20%. The crystallization of the PTT filaments is controlled by rapidly cooling the filaments with cold air having a temperature of 14° C. to 25° C. after extruding (melt spinning) the filaments. Rapidly cooling the filaments controls the cold crystallization of the filaments and limits the crystallization that occurs in the filaments as the filaments are cooled following extrusion by rapidly dropping the temperature of the filaments below the cold crystallization temperature of the polymer.

The process of U.S. Patent Application Publication No. 2003/0197303 A1 significantly improves the processability of PTT into staple fibers of sufficient denier to be utilized in carpets, particularly by limiting the degree of breakage of PTT undrawn filaments when the filaments are combined into a yarn and drawn. However, improvement in reduction of the variability of staple fiber length and width of staple fibers having sufficient denier to be utilized in carpets is still desired.

### SUMMARY OF THE INVENTION

The present invention is directed to a process for the production of staple fibers from a poly(trimethylene terephthalate) containing polymer for conversion into carpets which comprises: melt spinning a polymer into filaments at a melt temperature of from 220° C. to 290° C., wherein the polymer comprises at least 70 wt. % of a poly(trimethylene terephthalate) polymer comprised of at least 75 mol % trimethylene terephthalate; cooling the filaments with a liquid having a temperature of at most 20° C.; drawing the filaments subsequent to the step of cooling the filaments; and cutting the drawn filaments into staple fibers.

### BRIEF DESCRIPTION OF THE DRAWINGS

FIG. 1 is a schematic illustrating a process for melt-spinning a polymer to produce an undrawn yarn.

FIG. 2 is a schematic illustrating a process for drawing, crimping and cutting an undrawn yarn to product staple fiber.

### DETAILED DESCRIPTION OF THE INVENTION

The present invention provides a process for producing staple fibers from a polymer formed predominantly or exclusively of poly(trimethylene terephthalate) (the “PTT polymer”), where the staple fibers have a denier such that the staple fibers may be used to produce carpet. The process of the invention utilizes a cold liquid having a temperature of at most 20° C. to rapidly cool filaments melt spun from the PTT polymer. The cold liquid conducts heat away from the melt-spun filaments more efficiently than cooling solely with a cold air stream. Further, the temperature of the cold liquid may be reduced, for example below 13° C., relative to a cold air stream enabling the cold liquid to cool the filaments more rapidly than the filaments may be cooled solely with a cold air stream. Therefore, the cold liquid cools the melt-spun PTT filaments quite rapidly, thereby inhibiting crystallization in the filaments and minimizing the variation of the degree of crystallinity in the filaments more effectively than cooling solely with a cold air stream. The filaments are then processed to produce staple fibers that, as a result of the minimized degree of variation of crystallinity in the filaments, have a minimal variation in the staple fiber length and denier. The staple fibers having minimal variation in the staple fiber length and denier may be processed into carpets without the difficulties attendant in processing staple fibers of varying lengths and denier.

As used herein, the term “crystallinity” is a measure of the degree (or fraction, as %) of crystallization of a yarn. Crystallinity may be determined using a differential scanning calorimeter (DSC), for example, a Perkin-Elmer DSC-7. A sample of yarn is placed in an aluminum pan and is heated from 30° C. to 270° C. at a rate of 10° C. per minute. The heat of fusion (AH) of the melting endotherm is measured with the DSC at about 228° C. if the PTT polymer is a homopolymer with no added polymers, and from about 215° C. to about 228° C. if the PTT polymer contains comonomers or other polymers. If the DSC scan shows any low temperature cold crystallization or pre-melting exotherms, as shown by an absorption at from about 70° C. to about 150° C., the measured heat of fusion may be corrected by subtracting the measured exotherms from the heat of fusion to give the corrected heat of fusion (ΔH_{corrected}). If no low temperature exotherms are shown by the DSC scan then, for the purposes of the equation below, ΔH_{corrected} will equal the measured ΔH at about 215° C. to 228° C. The crystallinity (%) of the sample may be calculated according to the following equation:

Crystallinity (%)=(ΔH_{corrected}/ΔH_{f})*100

where ΔH_{f} is the heat of fusion of 100% crystalline PTT, which is defined as 35 cal/g.

Alternatively, the heat of fusion ΔH may be measured by heating the yarn to a temperature above its melting point, preferably to a temperature of from 245° C. to 255° C. until the yarn is completely melted, cooling the melted yarn to a temperature of from about 160° C. to 180° C., and then reheating the cooled melted yarn to a temperature of 270° C. at a rate of 10° C. per minute. Upon reheating through the melting point, the heat of fusion (ΔH) is measured with the DSC at about 228° C. if the PTT polymer is a homopolymer with no additional polymers, or from about 215° C. to about 228° C. if the PTT polymer contains other comonomers or other polymers. No correction is required for low temperature cold crystallization exotherms as heating the yarn above the melting point initially before measuring the heat of fusion exotherm eliminates crystallinity that causes the low temperature exotherms. The percent crystallinity may be determined according to the above equation where ΔH_{corrected} is equal to ΔH.

The degree of crystallinity of the yarn is also related to the density of the yarn. Specifically, the percentage of the yarn that is crystalline can be determined from the measured density according to the following equation: % crystallinity=Dc/Dm×[(Dm−Da)/(Dc−Da)]×100%, where Dm is the measured density, Dc is the density of 100% crystalline yarn, and Da is the density of 100% amorphous yarn (0% crystallinity). Dc=1.442 and Da=1.295 for PTT yarns. The measured density Dm may be determined in a density/gradient column at a temperature of 23±0.1° C. Sodium bromides of two concentrations may be used to bracket the expected density of the materials to be tested.

The PTT polymer used in the process of the present invention is a polymer comprising at least 70 wt. % poly(trimethylene terephthalate) comprised of at least 75 mol % trimethylene terephthalate (the “PTT polymer”). The PTT polymer may be a PTT homopolymer, a PTT co-polymer containing minor amounts of non-PTT co-monomers, a blend of a PTT homopolymer with minor amounts of other polymers, or a PTT co-polymer containing minor amounts of non-PTT co-monomers blended with minor amounts of other polymers. “Non-PTT co-monomers” as used herein, are defined as monomers in a polymer containing repeating trimethylene terephthalate units that may replace at least one of the monomers that form trimethylene terephalate units, specifically 1,3-propanediol and terephthalic acid or dimethylesterterephthalate, and be incorporated into the polymeric chain without forming a trimethylene terephthalate unit. Such non-PTT co-monomers include, but are not limited to, ethylene glycol, butylene glycol, 1,4 cyclohexanedimethanol, oxalic acid, succinic acid, phthalic acid, 2,6-naphthalenedicarboxylic acid, 5-sodiumsulfoisophthalic acid, isophthalic acid, and/or adipic acid. The PTT polymer may contain up to 25 mol % non-PTT co-monomers, or may contain at most 15 mol %, or at most 10 mol %, or at most 5 mol % non-PTT co-monomers. The PTT polymer may contain no non-PTT co-monomers (i.e. the PTT polymer is a homopolymer).

Known methods may be used as a method for producing a PTT homopolymer or co-polymer used in the process of the present invention. For example, terephthalic acid and/or dimethylterephthalate and 1,3-propanediol, and optionally a non-PTT co-monomer, may be esterified to form an oligomer that may be polymerized in the presence of a catalyst under reduced pressure at a temperature of from 240° C. to 280° C.

Other polymers may be blended with a PTT homopolymer or a PTT co-polymer to form the PTT polymer for use in the process of the present invention, where such polymers include polyesters such as poly(ethylene terephthalate), poly(butylene terephthalate), poly(ethylene naphthalate), and poly(trimethylene naphthalate) and polyarnides such as poly(ε-caproamide) sold as NYLON-6 and poly(hexamethylene adipamide) sold as NYLON-6,6. Such polymers may be blended with the PTT homopolymer or PTT co-polymer by heating each polymer above its melting point and mixing the molten polymers. The other polymers that may be included in the PTT polymer do not exceed 25 wt. %, or 15 wt. %, or 10 wt. %, or 5 wt. % of the PTT polymer. In an embodiment, the PTT polymer contains no other polymers other than PTT.

Various additives may also be included in the PTT polymer used in the process of the present invention. For example, additives selected from delustering agents, flame retardant agents, defoaming agents, ultraviolet ray absorbents, infrared ray absorbents, isochromatic agents, and optical brighteners may be included in the PTT polymer. Such additives may be incorporated in the PTT polymer by adding the additives to the molten PTT polymer and mixing the additives in the molten PTT polymer.

The PTT polymer useful in the process of the present invention may have an intrinsic viscosity of at least 0.7 dl/g, or at least 0.8 dl/g, or at least 0.9 dl/g. In an embodiment, the PTT polymer may have an intrinsic viscosity of from 0.7 to 1.4 dl/g. Preferably, the PTT polymer has an intrinsic viscosity of from 0.8 to 1.2 dl/g. Intrinsic viscosity may be measured by dissolving the PTT polymer in a solvent of phenol and 1,1,2,2-tetrachloroethane (60 parts phenol, by volume, 40 parts 1,1,2,2-tetrachloroethane, by volume) and measuring at 30° C. the intrinsic viscosity of the dissolved polymer on a relative viscometer, preferably Model No. Y501B available from Viscotek Company. The PTT polymer useful in the process of the present invention may also have a melting point within the range of from 210° C. to 235° C.

The PTT polymer may be dried to a constant moisture level of 50 ppm or less prior to melt spinning the polymer. Minimizing the moisture content of the PTT polymer prior to melt spinning may reduce degradation of the polymer by hydrolysis during melt spinning. The moisture content of the PTT polymer may be reduced to 50 ppm or less in a commercial dryer using dessicated air, for example, commercial dryers equipped with molecular sieves, vacuum systems, and/or lithium chloride desiccants may be used to reduce the moisture content of the PTT polymer.

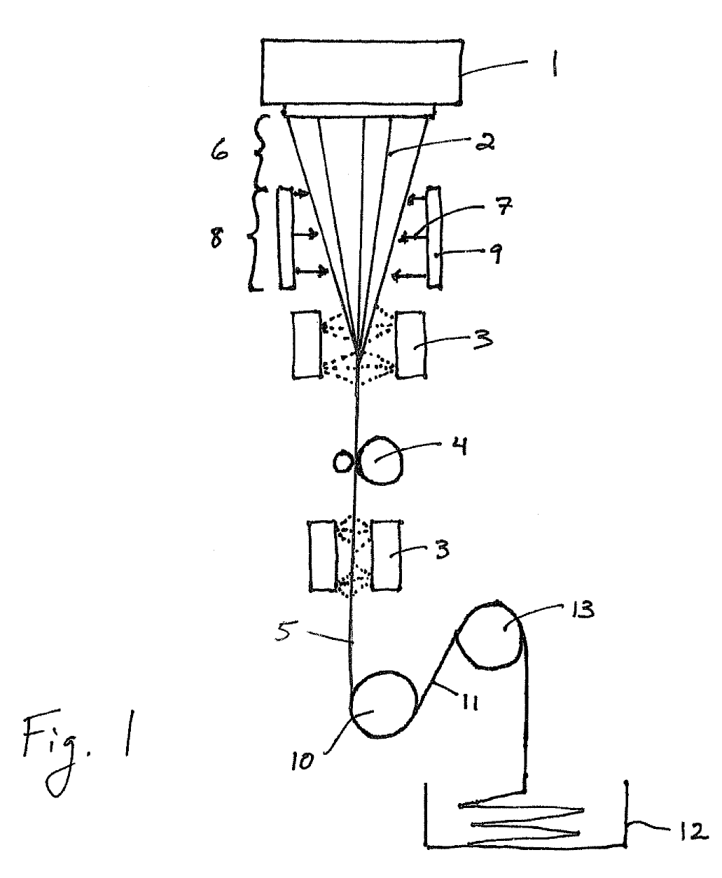

Referring now to FIG. 1, in accordance with the process of the present invention, the PTT polymer is melt spun into a plurality of filaments by feeding the PTT polymer, typically in the form of chips or pellets, to an extruder operating at a temperature of from 240° C. to 290° C. to melt the polymer, and extruding the molten PTT polymer through a spinneret 1 to form a plurality of filaments 2. Alternatively, the PTT polymer may be melted in a heater prior to being fed to the extruder by heating the PTT polymer to a temperature above the melting point of the PTT polymer. The extruder may be a conventional single screw or twin screw thermoplastic extruder having the spinneret 1 attached to the outlet of the extruder.

The extruder may be operated at a temperature effective to melt the PTT polymer without significantly degrading the polymer. The temperature may be from 240° C. to 290° C., where temperatures from 250° C. to 275° C. are preferred. Temperatures exceeding 290° C. tend to degrade the PTT polymer, and are less desirable. The tenacity of the spun filaments may be optimized at temperatures exceeding 245° C., therefore, depending on the composition of the PTT polymer, it may be preferable to melt spin the PTT polymer at a temperature of at least 245° C. For example, if the PTT polymer is a PTT homopolymer with no other polymers blended therein, the tenacity of the spun filaments may be higher if the filaments are melt-spun at a temperature of at least 245° C. In an embodiment of the process of the invention, the extruder may be a multi-stage extruder wherein the PTT polymer is heated at different temperatures within the stages of the extruder. For example, the extruder may be a four-stage extruder in which the PTT polymer is heated to 245° C. to 250° C. in the first stage, from 250° C. to 255° C. in the second stage, and from 255° C. to 260° C. in the third and fourth stages.

The spinneret 1 has a plurality of die holes through which the PTT polymer is extruded into PTT filaments 2. The die holes may be shaped to provide the extruded filaments with a desired cross-sectional shape. For example, the orifices may be shaped to provide filaments with a round, trilobal, delta (triangular), multi-lobed, or hollow cross-sectional shape. The spinneret die holes have a size selected to provide PTT filaments 2 that may be processed to form PTT staple fibers useful to prepare carpets. The die holes may have a size selected from 0.2 to 0.6 mm. The spinneret 1 preferably has sufficient die holes to provide a sufficient number of PTT filaments 2 to form into a yarn that may be processed into a PTT staple fiber useful in carpet applications. For example, the spinneret 2 may have from 10 to 100 die holes through which the molten PTT polymer may be extruded into filaments. Multiple spinnerets (not shown) may be coupled to the extruder to enable multiple yarns to be spun simultaneously from the molten PTT polymer.

The spun PTT filaments 2 are then cooled to reduce the temperature of the PTT filaments and to solidify the PTT filaments. In accordance with the process of the present invention, the melt spun PTT filaments 2 are cooled by contact with a liquid having a temperature of at most 20° C. In a preferred embodiment, the melt-spun PTT filaments 2 have a temperature above the cold crystallization temperature of the PTT polymer when contacted and cooled with the cold liquid. The liquid may be water, an aqueous solution containing, for example, a spin finishing agent, or a non-aqueous liquid. In one embodiment, the liquid is a commercially available aqueous spin finishing agent containing water and a lubricant, and optionally a surfactant, an anti-static agent, and/or a fungicide.

The temperature (Tₗ) of the liquid used to cool the PTT filaments is at most 20° C., or at most 15° C., or at most 13° C., or at most 10° C., or at most 7° C. If the liquid is an aqueous solution, the temperature of the liquid is preferably from 0° C. to 20° C., or from 0° C. to 15° C., or from 0° C. to 13° C., or from 0° C. to 10° C., or from 0° C. to 7° C. If the liquid is non-aqueous—for example acetone, tetrahydrofuran, methanol, ethanol, or methylene chloride—the temperature of the liquid used to cool the PTT filaments may be less than 0° C.

The PTT filaments 2 may be cooled by contact with the cold liquid utilizing any means convenient for applying the cold liquid to the filaments as the filaments are spun. In an embodiment, the cold liquid may be sprayed onto the PTT filaments. The cold liquid is preferably sprayed onto the PTT filaments with one or more commercially available atomizers 3 which spray a fine mist of the liquid onto the filaments 2. In another embodiment, the PTT filaments 2 may be contacted with the cold liquid to cool the filaments by contacting the filaments and the cold liquid together on a surface. The PTT filaments and the cold liquid may be contacted together on a surface in a spin finish applicator 4, where the surface may be a kiss roll over which the filaments and the liquid pass. In another embodiment, the PTT filaments 2 and the cold liquid may be contacted to cool the filaments by passing the filaments through a dip bath (not shown) of the liquid. In another embodiment, the PTT filaments 2 may be contacted with a cold liquid to cool the filaments utilizing more than one means for contacting a cold liquid with the filaments. For example, the PTT filaments 2 may be contacted with a cold spin finish liquid by a spin finish applicator 4, and then the filaments may be sprayed with a mist of cold water, for example by one or more atomizers 3, or may be passed through a dip bath of cold water.

The PTT filaments 2 may be contacted with the cold liquid individually, or a plurality of the filaments may be combined into an undrawn PTT yarn 5 and then contacted with the cold liquid, or a plurality of the filaments 2 may be combined into an undrawn yarn while simultaneously being contacted with the cold liquid. In an embodiment, a plurality of the PTT filaments 2 may be combined into an undrawn PTT yarn 5 prior to being contacted with the cold liquid or simultaneously with being contacted with the cold liquid, where the undrawn yarn 5 containing the filaments is contacted with the cold liquid in spin finish applicator 4. In an embodiment, the cold liquid applied to the PTT filaments in the undrawn PTT yarn 5 in the spin finish applicator 4 may contain a spin finish agent. Subsequent to being contacted with the cold liquid in the spin finish applicator 4, the PTT filaments in the undrawn PTT yarn 5 may be further cooled by spraying the undrawn yarn 5 with a cold liquid, for example water, preferably using one or more atomizers 3 to spray the cold liquid on the undrawn yarn 5 as a mist, and/or the undrawn yarn 5 may be passed through a dip bath of a cold liquid. In another embodiment, the plurality of PTT filaments 2 may be combined into an undrawn PTT yarn 5 prior to being contacted with the cold liquid, where the cold liquid is subsequently sprayed onto the undrawn yarn to cool the filaments of the undrawn yarn 5. In another embodiment, the plurality of PTT filaments 2 may be combined into an undrawn PTT yarn 5 prior to being contacted with the cold liquid, where the undrawn yarn 5 is subsequently passed through a dip bath containing the cold liquid to cool the filaments of the undrawn yarn.

Alternatively, a plurality of the PTT filaments 2 may be individually cooled with the cold liquid and then combined to form an undrawn PTT yarn 5. In an embodiment, the PTT filaments 2 may be individually sprayed with a cold liquid, preferably using an atomizer 3 to spray the cold liquid on the filaments, and/or the individual filaments 2 may be passed through a dip bath (not shown) of a cold liquid, and then the filaments 2 may be combined into an undrawn PTT yarn 5. A spin finish agent may then be applied to the PTT filaments in the undrawn PTT yarn 5 by contacting the yarn with the spin finish agent in a spin finish applicator 4, where the spin finish agent may be a cold liquid used to further cool the filaments 2.

The PTT filaments 2 may pass through a delay quench zone 6 located directly adjacent to the spinneret 1 so the filaments 2 enter the delay quench zone 6 immediately after exiting the spinneret 1 prior to being cooled. The delay quench zone 6 provides a zone in which the molten PTT filaments 2 may equilibrate prior to being subjected to cooling, thereby inhibiting the development of irregularities in the filaments such as uneven thickness or uneven elongation. The delay quench zone 6 may have a length of from 0.1-30 centimeters, preferably from 0.5-20 centimeters. The delay quench zone 6 may be held at temperatures of from 30° C. to 235° C.

In one embodiment of the process of the present invention the PTT filaments 2 may be cooled with a quench gas 7, preferably cool or cold air, prior to being cooled with the cold liquid. The PTT filaments 2 may be cooled by exposing the filaments to quench gas 7 in a quench gas zone 8, where the quench gas zone 8 may have a length of from 0.1 to 2 meters. The quench gas 7 preferably has a cold temperature relative to the temperature of the PTT filaments 2 exiting the delay quench zone 6 or spinneret 1. Preferably the quench gas temperature is from 14° C. to 30° C., and most preferably the quench gas 7 has a temperature of at most 25° C. If no delay quench zone 6 is utilized, the quench gas temperature is preferably at the low end of the temperature range above, preferably from 14° C. to 20° C. The quench gas 7 may be blown across the PTT filaments 2, or optionally may be blown along the length of the filaments 2. The quench gas 7 may be blown at a velocity of from 0.1 to 0.8 m/sec, or from 0.3 to 0.7 m/sec.

In an embodiment, the PTT filaments 2 may pass through a quench box or cylinder 9 surrounding the filaments 2 which defines the quench gas zone 8 in which the filaments 2 are exposed to the quench gas 7. The quench gas 7 may be directed inward from the interior surface of the quench air box or cylinder 9 to cool the PTT filaments 2. Alternatively, the quench gas 7 may be directed from the top or bottom of the quench box or cylinder 9 axially along the PTT filaments 2 as they pass through the quench box or cylinder 9. In another embodiment, the PTT filaments may pass around a quench gas tube (not shown) which directs quench gas radially outwards from nozzles in the tube at the filaments as the filaments pass the quench gas tube.

The cooled PTT filaments combined into an undrawn PTT yarn 5 are then taken up by a take-up mechanism 10 operating at a desired take-up speed. The take-up mechanism 10 may be any conventional mechanism for taking up a multi-filament yarn. In an embodiment, the take-up mechanism 10 may be godet rolls operating at the desired take-up speed.

The take-up mechanism 10 takes up the undrawn PTT yarn 5 at a speed that does not impart much axial orientation to the filaments in the yarn or the yarn itself and causes little, if any, crystallization in the yarn filaments. The take-up mechanism 10 may take the undrawn PTT yarn 5 up at a take-up speed of at most 1500 m/min, or at most 1400 m/min, or at most 1300 m/min, or at most 1200 m/min, and typically at least 100 m/min, or 200 m/min, or 300 m/min. In an embodiment of the process of the present invention the take-up mechanism 10 may take up the undrawn PTT yarn 5 at a take-up speed of from 100 to 1500 m/min, or from 100 m/min to 1000 m/min or from 200 to 900 m/min, or from 300 to 700 m/min, or from 400 to 500 m/min.

The take-up speed may be selected to minimize the amount of crystallinity in the filaments 2 or undrawn yarn 5, and to minimize the variability of staple fiber length, denier, and tenacity of staple fibers formed from the filaments 2 or undrawn yarn 5. Slower take-up speeds increase the length of time the filaments 2 or the undrawn yarn 5 are exposed to the cooling liquid, thereby increasing the rapidity of cooling of the filaments 2 or undrawn yarn 5 and decreasing the crystallinity of the resulting filaments 2 or undrawn yarn 5. The resulting filaments 2 or undrawn yarn 5 have a low crystallinity, and may be processed to produce a staple fibers having minimal variation in staple fiber length, denier, and tenacity. As noted above, the take-up speed of the undrawn yarn 5 may be from 500 to 1500 m/min, where take-up speeds from 500 m/min to 1000 m/min, or from 550 m/min to 900 m/min are preferred.

In an embodiment, a take-up speed may be selected based upon the temperature of the liquid used to cool the filaments 2 or yarn 4 (Tₗ), the temperature at which the spun undrawn yarn 4 is to be maintained in a tow can (T_{c}), as described below, and the denier of the finished staple fiber (d). The take-up speed (S) may preferably be selected to fulfill the following equation, where temperature of the liquid used to cool the filaments Tₗ is from 0° C. to 20° C., the tow can temperature T_{c} is from 15° C. to 30° C., and the denier of the finished staple fiber d is from 8 g/d to 30 g/d: S=(√d)×(Tₗ)×(T_{c}), where S is <=65000, or preferably <=60000, or more preferably <=55000.

The taken-up undrawn PTT yarn 11 formed of the cooled PTT filaments is then collected for drawing. The taken-up undrawn PTT yarn 11 may be collected for drawing by spooling the undrawn yarn 11 into a tow can 12—preferably by converging a plurality of undrawn PTT yarns (not shown), each containing a plurality of cooled PTT filaments, from a plurality of take-up rolls onto a large roller 13 and dropping the converged undrawn yarns from the large roller into a tow can 12—and subsequently loading the undrawn yarn 11 from the tow can 12 onto a creel (not shown). Alternatively, the taken-up undrawn PTT yarn 11 may be loaded directly onto a creel. Typically, for large production runs, the undrawn PTT yarn 11 will be spooled into a tow can 12 and subsequently loaded onto a creel when required in a subsequent drawing step. Loading the taken-up undrawn PTT yarn 11 directly onto a creel may be most useful when processing smaller quantities of yarn to be used immediately in a drawing process.

The undrawn PTT yarn 11 formed of the cooled PTT filaments collected in a tow can 12 may be stored in the tow can 12 for a period of time prior to being drawn. If the undrawn PTT yarn 11 is stored in a tow can 12 prior to drawing, the tow can 12 containing the undrawn yarn 11 is preferably stored at a temperature (Tₜ) of at most 30° C., or at most 25° C., or at most 20° C., or from 15° C. to 30° C., and preferably from 18° C. to 25° C. to inhibit the undrawn yarn from shrinking.

The filament diameter and number of filaments used to form the undrawn PTT yarn may be controlled to produce an undrawn yarn having a denier especially useful to produce a staple carpet fibers—which typically are much thicker and have a significantly higher denier than staple fibers used in textile applications. In particular, the number of filaments and filament diameter may be controlled to produce an undrawn PTT yarn having a denier of at least 30, or at least 40, or at least 50, and at most 150, or at most 100, or at most 80.

Cooling the PTT filaments of the undrawn PTT yarn with cold liquid may provide an undrawn PTT yarn having a low degree of crystallinity. In an embodiment, the undrawn PTT yarn formed of PTT filaments cooled with cold liquid may have a crystallinity of at most 20%, as measured by X-ray diffraction, or at most 18%, or at most 15%, or at most 10%. The undrawn PTT yarn formed of PTT filaments cooled with cold liquid may also exhibit a low degree of variation of crystallinity over the length of the yarn. For example, the undrawn PTT yarn stored in a tow can may exhibit a coefficient of variation of crystallinity of at most 10%, or at most 8%, or at most 5% from the top of the tow can to the bottom of a tow can.

The undrawn PTT yarn formed of the cooled PTT filaments may be loaded onto a creel from a tow can in preparation for drawing, or, as noted above, the undrawn yarn may be directly loaded onto a creel. In order to load the undrawn PTT yarn from the tow can onto a creel, the undrawn yarn is drawn from the tow can and wound about a creel.

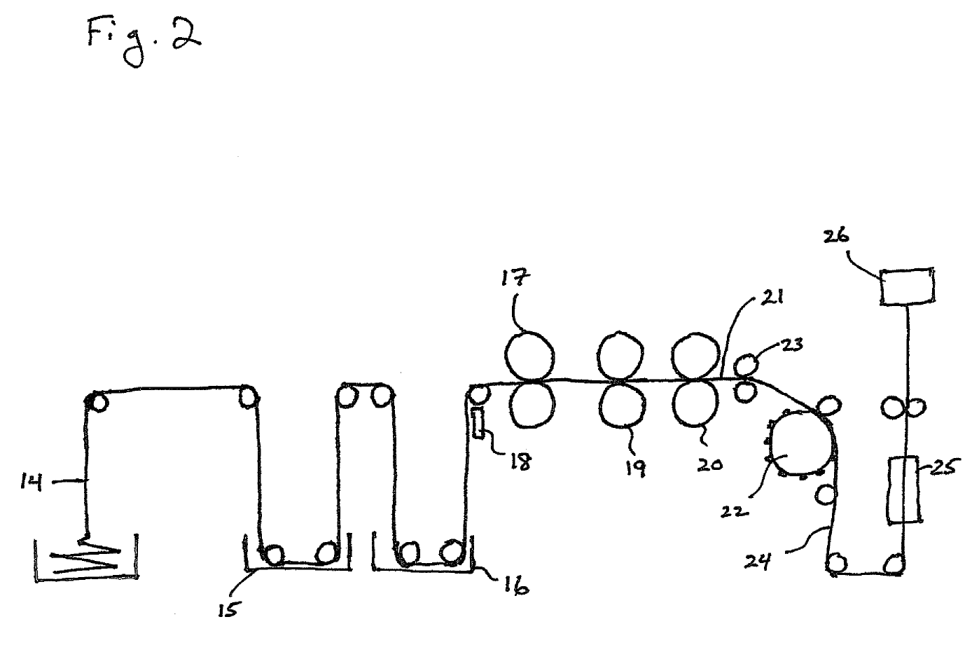

Referring now to FIG. 2, subsequent to the step of cooling the PTT filaments, the cooled PTT filaments in the form of an undrawn PTT yarn 14 may then be drawn by drawing the undrawn yarn. In preparation for drawing, the undrawn PTT yarn 14 containing the PTT filaments may be wetted and then heated prior to drawing. The undrawn PTT yarn 14 may be wetted by passing the undrawn yarn through a wetting bath 15 of water or aqueous mixture having a temperature above the glass transition temperature of the undrawn yarn 14 but below the cold crystallization temperature of the undrawn yarn 14, typically a temperature of at least 35° C., or at least 45° C., or at least 55° C., and at most 75° C., or at most 70° C., or at most 65° C., or a temperature of from 35° C. to 75° C., or from 45° C. to 70° C., or from 55° C. to 65° C. The undrawn PTT yarn 14 may be heated by passing the undrawn yarn 14 through the wetting bath 15, where the wetting bath 15 has a temperature of from 50° C. to 75° C., or from 55° C. to 70° C. and the undrawn yarn 14 is contacted with the wetting bath 15 for a sufficient time to heat the undrawn yarn 14 to a temperature above its glass transition temperature, which may be from 35° C. to 45° C. Alternatively, the undrawn PTT yarn 14 may be heated after wetting the yarn in the wetting bath 15 by passing the undrawn yarn 14 through a heated aqueous or water bath 16 having a temperature of at least 50° C., or at least 55° C., or at least 60° C. and a temperature of at most 75° C., or at most 70° C., or at most 65° C., or a temperature of from 50° C. to 75° C., or from 55° C. to 70° C., or from 60° C. to 65° C. In another embodiment, the undrawn PTT yarn 14 may be heated by contacting the wetted undrawn yarn 14 with a heated godet 17 having a temperature of at least 50° C., or at least 55° C., or at least 60° C. and a temperature of at most 75° C., or at most 70° C., or at most 65° C., or a temperature of from 50° C. to 75° C., or from 55° C. to 70° C., or from 60° C. to 65° C.

In an embodiment, a lubricant may be applied to the undrawn PTT yarn 14 containing the filaments to facilitate drawing. The lubricant may be applied by including from 0.2 to 2 wt. % of the lubricant in the wetting bath 15 or in a heating bath 16 through which the undrawn PTT yarn 14 is passed prior to drawing. The lubricant may also be applied by spraying an aqueous solution containing from 0.2 to 2 wt. % of the lubricant on the undrawn PTT yarn through conventional spray nozzles 18 prior to drawing the undrawn yarn 14. Suitable lubricants include fatty esters, polyether copolymers that have an ethylene-oxide and/or propylene-oxide unit, nonionic surfactants including propylene-oxide and ethylene-oxide surfactants, and ionic surfactants such as sulfonic acid salts, phosphoric acid ester salts, and high molecular weight fatty acid salts.

The PTT filaments in the form of the undrawn PTT yarn 14—preferably wetted, preheated, and lubricated—may be drawn by heating and stretching the yarn. The undrawn PTT yarn 14 may be heated and stretched by passing the yarn over sets of heated godet rolls 19 and 20, where at least one set of heated godet rolls 20 is controlled to spin at a peripheral speed of from 3 to 4 times faster than a preceding set of godet rolls 19 so that the draw ratio for drawing the PTT filaments and yarn is from 3 to 4. In an embodiment, the undrawn PTT yarn 14 may be fed to a set of pre-draw rolls 19, which may have a temperature of at least 50° C., or at least 55° C., or at least 60° C., and at most 90° C., or at most 85° C., or at most 80° C., or at most 75° C., where the pre-draw rolls 19 may be controlled to spin at a selected peripheral speed, typically a peripheral speed of from 300 to 400 m/min. The undrawn PTT yarn 14 may then be fed to, and drawn by, a set of draw rolls 20, which may have a temperature of at least 80° C., or at least 90° C., or at least 95° C., and at most 125° C., or at most 120° C., or at most 115° C., or at most 110° C., where the draw rolls 20 may be controlled to spin at a peripheral speed of from 2.8 to 4.0 times the speed of the pre-draw rolls 19, typically a peripheral speed of from 1000 to 1600 m/min. The peripheral speed difference between the draw rolls 20 and the pre-draw rolls 19 causes the yarn to be drawn as it passes from the pre-draw rolls 19 to the draw rolls 20, where the draw ratio of the drawing process is the ratio of the speed of the draw rolls 20 to the pre-draw rolls 19.

The undrawn PTT filaments in the form of the undrawn PTT yarn 14 may be drawn at a relatively high draw ratio without significant breakage of the filaments of the yarn due to the low crystallinity of the undrawn filaments/yarn produced by contacting the undrawn filaments/yarn with the cold liquid while cooling the filaments/yarn from extrusion. The natural draw ratio at which the undrawn PTT yarn 14 may be drawn without significant breakage of filaments is preferably greater than 2.5, more preferably greater than 3.0, and may range from 2.8 to 4.0.

The drawn PTT filaments in the form of the drawn PTT yarn 21 may then be crimped to provide bulk to the drawn yarn. The drawn PTT yarn 21 may be crimped by passing the drawn yarn 21 over a crimper roll 22 operated at a pressure of from 0.2 to 0.5 MPa and at a temperature of from 120° C. to 200° C., preferably with the aid of steam or hot air. In an embodiment, the drawn PTT yarn 21 may be passed from the draw rolls 20 to a crimper roll 22 for crimping, or may be passed from the draw rolls 20 to a set of relaxation rolls 23 and then to a crimper roll 22 for crimping. The crimp in the drawn PTT yarn may be set by heating the drawn and crimped yarn 24 to dry and set the crimp in the drawn yarn. In an embodiment, the crimp may be set by passing the drawn and crimped PTT yarn 24 through a hot air tunnel 25 for a period of 5 to 20 minutes, or from 10 to 15 minutes, to dry and set the crimped drawn yarn 24.

The drawn PTT filaments in the form of the drawn PTT yarn, optionally crimped, may then be cut to form the PTT staple fibers useful for producing yarns that may be used to produce carpets. In an embodiment, the drawn PTT yarn may be cut at intervals of from 2.5 cm to 20.5 cm to form the PTT staple fibers. The drawn PTT yarn may be cut at intervals of uniform length to provide PTT staple fibers having similar lengths. In an embodiment, the drawn PTT yarn is cut with a rotary cutter 26 to form the PTT staple fibers.

The PTT staple fibers may have a denier useful to prepare carpet. In an embodiment, the PTT staple fibers may have a denier (d) of at least 8, or at least 10, or at least 15, and have a denier of at most 40, or at most 30, or at most 25, and may have a denier of from 8 to 30, or from 10 to 25, and most preferably from 13 to 21.

The process of the present invention provides substantially uniform PTT staple fibers so the PTT staple fibers produced by the process have consistent denier and may easily be processed into spun yarns for use in carpets. The PTT staple fibers produced by the process of the present invention may have substantially a similar denier with co-processed PTT staple fibers, where the coefficient of variation of measured denier between co-processed PTT staple fibers may be at most 9%, or at most 6%, or at most 5%, or at most 4%.

The substantially uniform PTT staple fibers produced by the process of the present invention also have a substantially uniform tenacity. In one embodiment, the PTT staple fibers produced by the process of the present invention have a substantially similar tenacity with co-processed PTT staple fibers, where the coefficient of variation of tenacity between co-processed PTT staple fibers may be at most 21%, or at most 15%, or at most 13%, or at most 11%. Tenacity, for purposes of the present invention, may measured with a Statimat ME tester with a load cell of 100 newtons. A pretension force of 0.05 g/d is applied to the fiber/yarn with a gauge length of 110 mm, and the tenacity is measured at a cross-head speed of 300 mm/min. The test is repeated ten times on segments of a selected yarn or fiber, and the average value of the ten measurements is defined as the tenacity of the yarn or fiber for purposes of the present invention.

The substantially uniform PTT staple fibers produced by the process of the present invention also may have a substantially uniform elongation at break. In one embodiment, the PTT staple fibers produced by the process of the present invention have a substantially similar elongation at break with co-processed PTT staple fibers, where the coefficient of variation of elongation at break between co-processed PTT staple fibers may be at most 35%, or at most 25%, or at most 20%. As used herein, the term “elongation at break” is defined as the increase in length of a yarn caused by a tensile force from a relaxed state to yarn breakage, measured as a percent increase in length of the yarn at its breaking point over the length of the relaxed yarn at full extension. The elongation at break may be measured in a Statimat tensile tester according to American Standard Testing and Materials (ASTM) Method D2101. An average often tests is reported.

The PTT staple fibers produced according to the process of the present invention may be used in to prepare carpets. The PTT staple fibers may be formed into spun yarns using conventional processes for forming spun yarns from staple fibers, including blending, carding, drafting, and spinning. The PTT staple fibers may be blended with other staple fibers to form the spun yarns. The spun yarns containing the PTT staple fibers may be used to prepare carpets in accordance with conventional carpet manufacture processes.

### EXAMPLE 1

A PTT fiber was spun, cooled with a cold liquid, drawn, and cut into staple fiber according to the process of the present invention, and the coefficients of variation of the denier, tenacity, and elongation at break of the resulting staple fiber were measured. PTT chips having an intrinsic viscosity of 0.88 g/dl were dried at 135° C. for 8 hours. The moisture level of the dried PTT was less than 30 ppm. The dried PTT polymer was extruded at 258° C. and spun through a spinneret to produce filaments. The filaments were initially cooled with quench air having a temperature of 17° C., and then were cooled by applying a liquid spin finish having a temperature of 16° C. while bundling the filaments into a yarn. The cooled spun undrawn yarn was collected as a fiber tow on a creel at a take-up speed of 292 m/min. The collected undrawn yarn fiber tow was maintained at a temperature of 20° C. to relax the yarn. The relaxed undrawn yarn was then drawn at a temperature of 55° C. at a draw ratio of 3.8. The drawn yarn was cut into staple fibers and separated into four bales of staple fibers. The denier, tenacity, and elongation at break of PTT staple fibers from each bale was then measured and the coefficients of variation for each measured characteristic were calculated. The results are shown in Table 1 below.

TABLE 1

| | Bale 1 | Bale 2 | Bale 3 | Bale 4 |
|---|---|---|---|---|
| Denier (mean) | 19.7 | 18.9 | 17.6 | 17.9 |
| Denier CV % | 8.7 | 6.0 | 4.8 | 3.1 |
| Tenacity (g/d) (mean) | 2.1 | 2.0 | 2.2 | 2.2 |
| Tenacity CV % | 12.5 | 17.9 | 11.5 | 10.7 |
| Elongation at break | 127.2 | 100.3 | 106.9 | 116.1 |
| (%) (mean) | | | | |
| Elongation at break | 16.6 | 33.8 | 19.9 | 20.4 |
| CV % | | | | |

The staple fibers produced according to the present process showed little variation in the physical parameters measured, particularly with respect to the denier. The variation of the denier between the staple fibers was less than 10%, so the staple fibers produced by the process would be useful for use in the production of a PTT staple fiber carpet.

### EXAMPLE 2

A staple fiber was produced in accordance with the process of the present invention according to the method set forth in Example 1, except that the take-up speed was increased from 292 m/min to 400 m/min, the liquid spin finish had a temperature of 17° C. (1° C. warmer than Example 1), the quench air had a temperature of 15° C. (2° C. colder than Example), and only 1 bale of staple fiber was produced. The denier, tenacity, and elongation at break of PTT staple fibers from the bale were then measured several times, and the coefficients of variation for each measured characteristic were calculated. The results are set forth in Table 2 below.

TABLE 2

| | Bale 1 |
|---|---|
| Denier (mean) | 13.1 |
| Denier CV % | 6.3 |
| Tenacity (g/d) (mean) | 2.0 |
| Tenacity CV % | 20.5 |
| Elongation at break | 80.3 |
| (%) (mean) | |
| Elongation at break | 32.5 |
| CV % | |

The staple fibers produced according to the present process showed little variation in the physical parameters measured, however, the variation was more marked for each parameter than the staple fibers produced in Example 1 except the elongation at break of Bale 22. This is likely due to the increased take-up rate reducing the time of exposure of the filaments/undrawn yarn to the cold liquid spin finish. The variation of the denier between the staple fibers was less than 10%, so the staple fibers produced by the process would be useful for use in the production of a PTT staple fiber carpet.

What is claimed is:

1. A process for the production of staple fibers from poly(trimethylene terephthalate) for conversion into carpets which comprises:
melt spinning a polymer into filaments at a melt temperature of from 220° C. to 290° C., wherein the polymer comprises at least 70 wt. % of a poly(trimethylene terephthalate) polymer comprised of at least 75 mol % trimethylene terephthalate;
cooling the melt spun filaments with a liquid having a temperature of at most 20° C.;
drawing the filaments subsequent to the step of cooling the filaments; and
cutting the drawn filaments into staple fibers.

2. The process of claim 1 wherein the cooled melt spun filaments are taken-up at a take-up speed of from 100 m/min to 1000 m/min, or from 200 m/min to 500 m/min.

3. The process of claim 1 wherein the filaments are cooled with a quench gas having a temperature of at most 25° C. prior to being cooled with the liquid having a temperature of at most 20° C.

4. The process of claim 1 wherein the filaments are passed through a delay quench zone prior to being cooled.

5. The process of claim 1 wherein the filaments are combined to form a yarn prior to drawing, the step of drawing the filaments comprises drawing the yarn, and the step of cutting the drawn filaments into staple fibers comprises cutting the yarn into staple fibers.

6. The process of claim 1 wherein filaments are cooled such that the cooled filaments have a crystallinity of at most 18%, or at most 15%, or at most 12%.

7. The process of claim 1 wherein the liquid comprises water.

8. The process of claim 1 wherein the liquid comprises a spin finish agent.

9. The process of claim 1 wherein the liquid has a temperature of at most 15° C., or at most 13° C., or at most 10° C.

10. The process of claim 1 wherein the filaments are cooled with the liquid by spraying the liquid on the filaments.

11. The process of claim 1 wherein the filaments are cooled with the liquid by contacting the liquid and the filaments on a surface.

12. The process of claim 1 wherein the filaments are cooled with the liquid by passing the filaments through a bath of said liquid.

13. The process of claim 1 wherein the filaments are collected and stored in a tow can prior to being drawn.

14. The process of claim 1 wherein the filaments are loaded onto a creel prior to being drawn.

15. The process of claim 1 wherein the filaments are heated to a temperature of from 35° C. to 75° C. prior to drawing.

16. The process of claim 1 wherein the draw ratio for drawing the filaments is from 3 to 4.

17. The process of claim 1 further comprising the step of crimping the drawn filaments prior to cutting the filaments.

18. The process of claim 1 wherein the melt spun filaments have a temperature above the cold crystallization temperature of the polymer when cooled with the liquid.
